(19) United States
(12) Patent Application Publication
(10) Pub. No.: US 2025/0103040 A1
(43) Pub. Date: Mar. 27, 2025

(54) REAL-TIME GAS-LIFT MONITORING SYSTEM USING AI TECHNIQUES

(71) Applicant: SAUDI ARABIAN OIL COMPANY, Dhahran (SA)

(72) Inventors: James O. Arukhe, Dhahran (SA); Torty C. Kalu-Ulu, Ras Tanura (SA); Mohammed H. Aleid, Al Qatif (SA); Suhail A. Samman, Riyadh (SA)

(73) Assignee: SAUDI ARABIAN OIL COMPANY, Dhahran (SA)

(21) Appl. No.: 18/472,739

(22) Filed: Sep. 22, 2023

(51) Int. Cl. G05B 23/02

(52) U.S. Cl. CPC G05B 23/0283

(57) ABSTRACT

A method for detecting a gas migration event in a gas-lift hydrocarbon production well. The method includes obtaining process data from the gas-lifted, hydrocarbon production well, the well controlled by a set of operation parameters and detecting, with a computational model, a gas migration event based on the process data. The method further includes adjusting one or more operation parameters in the set of operation parameters to mitigate the gas migration event based on the gas migration event and process data. The method further includes determining a maintenance action based on the gas migration event, generating an alert for the detected gas migration event, and performing the maintenance action on the production well.

### BACKGROUND

Hydrocarbon fluids are often found in hydrocarbon reservoirs located in porous rock formations far below the earth's surface. Production wells may be drilled to extract the hydrocarbon fluids from the hydrocarbon reservoirs. Often, hydrocarbon fluids are able to flow naturally through production wells because the pressure within the reservoir is high enough to encourage the hydrocarbons to the surface. However, when a reservoir becomes depleted, or is naturally a reservoir with low-pressure, gas-lift may be utilized to produce the hydrocarbon fluids.

Gas-lift uses a source of high-pressure gas to lower the density of or “lift” the hydrocarbon fluids to the surface. Gas-lift systems use an external source of gas which is injected into production tubing located in the production well. The gas mixes with the hydrocarbon fluids in the production tubing. This reduces the density of the hydrocarbon fluids until the mixture becomes light enough to flow using the available reservoir pressure.

Because of their complexity, gas-lift systems are often prone to issues or inefficiencies. For instance, inadequate tuning of the gas-lift process may lead to sub-optimal hydrocarbon production. In a more severe scenario, tubular gas migrations pose threat to safety and may lead to operational disruptions. To reduce the risk of operational disruptions, enhance operational safety and optimize well performance, gas-lift systems need to be constantly monitored, which proves to be time consuming and costly.

With the advance of technology, artificial intelligence has become an opportunity to automate and reduce some of the monitoring burden.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for detecting a gas migration event in a gas-lift hydrocarbon production well, then adjusting one or more operation parameters and/or performing a maintenance action accordingly. The method includes obtaining process data from the gas-lifted, hydrocarbon production well, that is controlled by a set of operation parameters and detecting, with a computational model, a gas migration event based on the process data. The method further includes adjusting one or more operation parameters in the set of operation parameters to mitigate the gas migration event based on the gas migration event and process data, determining a maintenance action based on the gas migration event, generating an alert for the detected gas migration event, and performing the maintenance action on the production well.

Embodiments disclosed herein generally relate to a system for detecting a gas migration event in a gas-lift hydrocarbon production well, along with adjustment of operation parameters and performing a determined maintenance action accordingly. The system includes the hydrocarbon production well, controlled by a set of operation parameters, a gas-lift system, coupled to the hydrocarbon production well, that includes a gas source and a gas pump that pumps gas from the gas source into a wellbore of the hydrocarbon production well, a data acquisition system that collects process data from a plurality of sensors disposed on the hydrocarbon production well, and a computer. The computer includes one or more computer processors and a user interface. The computer is communicatively connected to the data acquisition system and is configured to receive process data from the data acquisition system, and detect, with a computational model, a gas migration event based on the process data. The computer is further configured to adjust one or more operation parameters in the set of operation parameters to mitigate the gas migration event based on the gas migration event and process data, determine a maintenance action to be performed on the production well based on the gas migration event, and generate an alert for the detected gas migration event.

Embodiments disclosed herein generally relate to a non-transitory computer-readable memory for detecting a gas migration event in a gas-lift hydrocarbon production well and, additionally, adjusting operation parameters and performing a maintenance action accordingly. The non-transitory computer-readable memory includes computer- executable instructions stored thereon that, when executed on a processor, cause the processor to perform steps, including obtaining process data from a gas-lifted, hydrocarbon production well, where the production well is controlled by a set of operation parameters and detecting, with a computational model, a gas migration event based on the process data. The steps further include adjusting one or more operation parameters in the set of operation parameters to mitigate the gas migration event based on the gas migration event and process data, determining a maintenance action to be performed on the production well based on the gas migration event, and generating an alert for the detected gas migration event.

Other aspects and advantages of the claimed subject matter will be apparent from the following description and the appended claims.

### BRIEF DESCRIPTION OF DRAWINGS

FIG. 1 depicts an example of a conventional gas-lift well site in accordance with one or more embodiments.

FIG. 2 depicts a block diagram with an example of a hydrocarbon production well, a gas-lift system, a data acquisition system, a database and a gas-lift monitoring system in accordance with one or more embodiments.

FIG. 3 depicts an example of a high-level overview of a computational model in accordance with one or more embodiments.

FIG. 4 depicts an example of a high-level overview of an AI model in accordance with one or more embodiments.

FIG. 5 depicts an example of a high-level overview of a computational model in accordance with one or more embodiments.

FIG. 6 depicts an example diagram of a neural network in accordance with one or more embodiments.

FIG. 7 depicts a flowchart outlining the main steps in the process of monitoring a gas-lift system and performing resulting maintenance actions in accordance with one or more embodiments.

FIG. 8 depicts some examples of gas-lift hydrocarbon production well process data in accordance with one or more embodiments.

FIG. 9 depicts a flowchart in accordance with one or more embodiments.

FIG. 10 depicts a block diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a drilling operations sensor may reference two or more such drilling operations sensors.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in a flowchart may be omitted, repeated, and/or performed in a different order than the order shown. Accordingly, the scope disclosed herein should not be considered limited to the specific arrangement of steps shown in a flowchart.

Although multiple dependent claims are not introduced, it would be apparent to one of ordinary skill that the subject matter of the dependent claims of one or more embodiments may be combined with other dependent claims.

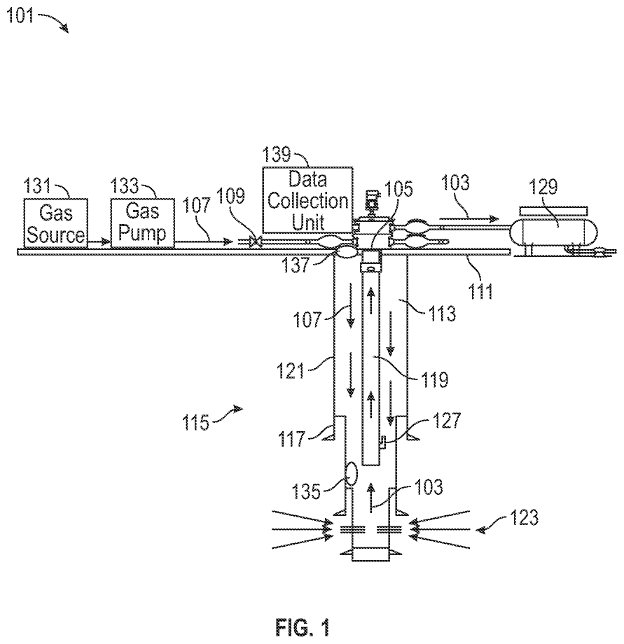

In the following description of FIGS. 1-10, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Gas-lift systems aid or increase hydrocarbon production in hydrocarbon production wells by injecting high-pressure gas, from the surface, down a casing annulus into fluids disposed in the production piping. The fluid density and hydrostatic pressure of the fluid are reduced by the introduction of the injected gas, thereby allowing the in-situ reservoir pressure to lift the lightened fluids.

In one or more embodiments, the gas used in a gas-lift system comes from an external source. Well sites using such a gas-lift system are called conventional gas-lift well sites. In other examples of gas-lift systems, the gas comes from the on-site hydrocarbon reservoir from which the well extracts the hydrocarbons. Well sites using such a gas-lift system are called in-situ gas-lift well sites.

FIG. 1 depicts an example of a conventional gas-lift well site (101). A gas-lift system “lifts” production fluids (103), such as oil, gas, and/or water, to the well exit (105) by lowering the density of the production fluids (103) with high pressure gas (107). In one or more embodiments, the gas (107), commonly nitrogen, is pumped from a gas source (131) using a gas pump (133) and is supplied into the well (115) through a surface gas injection valve (109). The gas source (131) can be of many shapes and sizes. In one or more embodiments, the gas source (131) and gas pump (133) are located near the well site (101), as illustrated in FIG. 1. In other examples, the gas source (131) and gas pump (133) may be located at any distance from the well site (101). The surface gas injection valve (109), disposed at the surface (111) and connected to an annulus (113) of the well (115), controls the flow of the gas (107) and injects the gas (107) into the annulus (113) with a user-defined pressure, which can be considered as high, according to one or more embodiments. The annulus (113) consists of the space between the casing (117) and the main inner pipe (119) and is configured to isolate the gas (107), allowing the gas (107) to flow the depth of the well (115) without mixing with other fluids.

The casing (117), disposed in the well (115) against the wellbore (121) and typically formed of a durable material such as steel, extends to a depth above the reservoir (123). The casing (117) isolates the subsurface fluids and supports the wellbore (121), the drilled hole comprising the well (103), up to the depth above the reservoir (123). At the other end, the wellbore (121) extends through the reservoir (123) beneath the casing (117). The reservoir (123) is disposed below the surface (111) of the earth in porous rock formations and is the source of the production fluids (103).

A main inner pipe (119), disposed in the wellbore (121), extends from the well exit (105) to a depth above the reservoir (123) and is a conduit for production fluids (103) to exit the well. In one or more embodiments, the main inner pipe (119) may be formed of tempered steel or equivalent. For the embodiment depicted in FIG. 1, the production fluids (103) are oil. The oil flows from the reservoir (123) into the wellbore (121), through the casing (117), and into the main inner pipe (119). If the reservoir (123) has enough pressure, the oil travels upwards in the main inner pipe (119) to the surface (111). Conversely, if the reservoir (123) does not have enough pressure to lift the oil by itself, gas (107) is injected into the oil.

At a given pressure that may be considered as high, the gas (107) enters the main inner pipe (119) through a downhole gas injection valve (127) and mixes with the production fluids (103) disposed in the main inner pipe (119). The downhole gas injection valve (127) forms a hydraulic connection between the annulus (113) and the main inner pipe (119) and is configured to allow the flow of the gas (107) from the annulus (113) into the main inner pipe (119). In one or more embodiments, the downhole gas injection valve (127) is composed of stainless steel or the equivalent. The injection pressure, combined with the lighter weight of the gas (107), lowers the density of the production fluids (103) until the mixture becomes light enough to flow towards the well exit (105) and into a production tank (129). The production tank (129) is a storage tank, disposed at the surface (111), that collects and stores the production fluids (103) after the production fluids (103) exits the well (115). In some instances, the production fluids (103) may be directly transported to (e.g., by a pipeline), or otherwise processed by, an oil and gas processing facility.

In accordance with one or more embodiments, one or more downhole sensors (135) are disposed within the well (115). The one or more downhole sensors (135) measure downhole fluid and process properties such as gas flow rate, downhole gas injection rate, downhole liquid production rate, downhole pressure, downhole temperature, and downhole gas concentration. In one or more embodiments, the downhole sensors (135) are grouped together and located on the side of the wellbore (121), as illustrated in FIG. 1. In other examples, the downhole sensors (135) may be separated and located anywhere below the surface (111).

In accordance with one or more embodiments, one or more surface sensors (137) are disposed at, or above, the surface (111) of the well (115). The one or more surface sensors (137) measure fluid and process properties at the surface (111) such as surface pressure, gas injection pressure, and gas injection temperature. In one or more embodiments, the surface sensors (137) are grouped together and located in the vicinity of the well exit (105), as illustrated in FIG. 1). In other examples, the surface sensors (137) may be separated and located anywhere at or above the surface (111). In one or more embodiments, the downhole sensors (135) or surface sensors (137) further include an acoustic sensor, such as a geophone, acquiring acoustic data that is added to the process data. In one or more embodiments, the downhole sensors (135) or surface sensors (137) further include at least one contamination sensor, configured to detect a presence, and possibly a concentration of contaminant in a produced hydrocarbon. The data measured by the downhole sensors (135) and surface sensors (137) are recorded and/or stored using a data collection unit (139). In one or more embodiments, the data collection unit (139) is located in the vicinity of the well exit (105), as illustrated in FIG. 1. In other examples, data collection unit (139) may be located anywhere.

The gas-lift well (115) is operated according to a set of operation parameters, that directly influence the hydrocarbon production. In one or more embodiments, the set of operation parameters includes a gas-lift stability, a gas injection rate, a gas injection pressure, a gas-to-liquid ratio, valve opening and closing pressures and a hydrocarbon production rate. Gas lift stability refers to the ability of a gas-lift system to maintain consistent and efficient operations over time without experiencing issues that could disrupt production. Instabilities in gas-lift operations can lead to reduced production rates, increased operational costs, and potential damage to equipment. A notable example of gas-lift instability is a slug flow, in which large pockets of gas and liquid alternate in the production tubing, causing rapid changes in pressure and flow rates. A slug flow may lead to inefficient lifting, decreased production and wear and tear on well equipment. The gas injection rate is typically balanced in order to create sufficient buoyancy to lift the fluids without causing excessive gas breakout at the surface. Over-injecting gas might lead to inefficient gas usage, while under-injecting gas could result in poor production rates. The gas injection pressure is usually selected to ensure efficient fluid lifting while avoiding gas-lift instabilities. Injecting gas at a too high pressure may lead to gas breakout at the surface, resulting in inefficient gas utilization. Injecting gas at a too low a pressure might not provide enough lifting force to overcome the hydrocarbon reservoir pressure. The gas-to-liquid ratio may also play a significant role in gas-lifted hydrocarbon production, as injecting too much gas may lead to inefficient fluid separation at the surface, while injecting too little gas may result in poor lifting performance. The opening and closing pressures of the surface gas injection valve (109) and the downhole gas injection valve (127) determine when gas injection starts and stops. Properly setting these pressures may help maintain an effective gas lift cycle. Last, the hydrocarbon production rate itself can be adjusted according to unforeseen circumstances. For instance, the hydrocarbon production rate may be intentionally reduced while a maintenance action is performed. In one or more embodiments, the operation parameters are accessed and controlled remotely, via a control system remotely located from the hydrocarbon production well or a device connected to the hydrocarbon production well via a network.

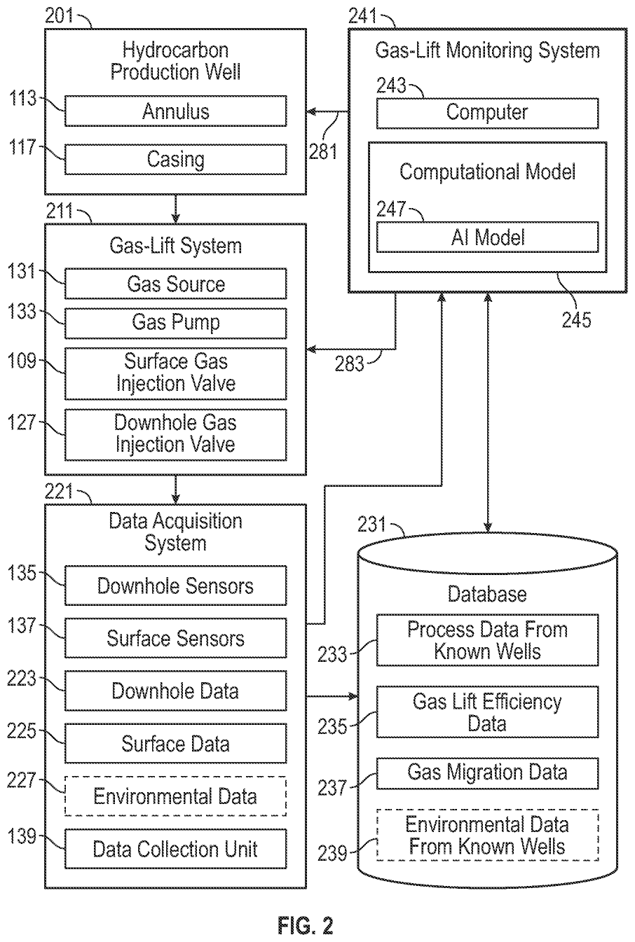

The block diagram in FIG. 2 depicts a hydrocarbon production well (201), a gas-lift system (211), a data acquisition system (221), a database (231), and a gas-lift monitoring system (241). In FIG. 2, the gas-lift monitoring system (241) is depicted as being comprised of various components, modules, and/or subsystems, where the components, modules, and/or subsystems may interact with each other. Further, in FIG. 2, the gas-lift monitoring system (241) is shown to interact with additional surrounding systems. One with ordinary skill in the art will recognize that the partitioning, organization, and interaction of the components, modules, and/or subsystems of the gas-lift monitoring system (241), alongside interactions with surrounding systems, in FIG. 2, is intended to promote clear discussion and should not be considered fixed or limiting. For example, FIG. 2 depicts a data acquisition system (221) as an independent entity, however, in some embodiments, the data acquisition system (221)—its data and/or its functionality—may be encompassed by the gas-lift monitoring system (241). Further, the gas-lift monitoring system (241) may store data objects and/or include a database such as the database (231). Further, in some embodiments, the gas-lift monitoring system (241) may further include the gas-lift system (211). In one or more embodiments, the gas-lift system (211) and data acquisition system (221) are connected to a backup power supply to ensure the continuous operation of the gas-lift system (211) and data acquisition system (221) in the event of a power disruption.

In FIG. 2, some elements of the hydrocarbon production well (201), gas-lift system (211) and data acquisition system (221) were discussed, at least in part, in the description of the gas-lift well site (101) in FIG. 1 and, for simplicity, will not be re-explained here. The hydrocarbon production well (201) includes an annulus (113), as depicted in FIG. 1, within the casing (117), that provides space for gas to flow. The gas-lift system (211) features a gas pump (133) that pumps gas from the gas source (131) into the annulus (113) through the surface gas injection valve (109). The gas flows from the surface to downhole through the annulus (113), where it is released into the production hydrocarbons through the downhole gas injection valve (127). As the injection of gas into the production hydrocarbons lowers the pressure of the production hydrocarbons, the mixture of the injected gas and production hydrocarbons, called production fluids, flows upward to the surface where it is collected into a production tank (See FIG. 1).

The data acquisition system (221) is designed to collect process data. In one or more embodiments, the processed data includes downhole data (223) and surface data (225). Some of the downhole data (223) are recorded by downhole sensors (135). As such, downhole data (223) may include measurements of downhole gas flow rate, downhole gas injection rate, downhole liquid production rate, downhole pressure, downhole temperature, downhole gas concentration, and acoustic data, such as a seismogram. In one or more embodiments, the downhole sensors (135) are located on the side of the wellbore, as illustrated in FIG. 1. Examples of downhole sensors include a downhole gas flow rate sensor, a downhole gas injection rate sensor, a downhole liquid production rate sensor, a downhole pressure sensor, a downhole temperature sensor a downhole gas concentration sensor, and an acoustic sensor, such as a geophone. In one or more embodiments, the downhole data (223) further include a subsurface equipment failure and maintenance report, that contains a description of the maintenance actions, failures, or any other issues that have occurred at the portion of the well site located in the subsurface. A notable example of an issue that may occur downhole and may be included in the subsurface equipment failure and maintenance report is a gas migration event. Gas migration can lead to gas pockets accumulating near the wellbore or surface, and can result in a blowout, a sudden and uncontrolled release of gas and other fluids, leading to potential explosions and fires. Gas migration can also cause pressure imbalances within the wellbore, leading to loss of well control and difficulties in maintaining wellbore stability. Examples of maintenance actions that may be included in the subsurface equipment failure and maintenance report are repair or replacement of the casing, liner, or protective coating of the wellbore (121).

Some of the surface data (225) are recorded by surface sensors (137). As such, surface data (225) may include measurements of surface pressure, surface temperature, gas injection pressure, gas injection temperature, and acoustic data, such as a seismogram. In one or more embodiments, the surface sensors (137) are located in the vicinity of the well exit (105), as illustrated in FIG. 1. Examples of surface sensors include a surface pressure sensor, a surface temperature sensor, a gas injection pressure sensor, an injection temperature sensor, and an acoustic sensor, such as a geophone. In one or more embodiments, the surface data (225) further include a surface equipment failure and maintenance report that contains a description of the maintenance actions, failures, or any other issues that have occurred at the portion of the well site located at the surface. Examples of issues occurring at the surface, that may be included in the surface equipment failure and maintenance report, are pump malfunctions, valve failures, or electrical problems. Examples of surface equipment maintenance include scheduled inspections, wellhead seal repairs, fire detection system testing, or calibration of the gauges.

The data acquisition system (221) in FIG. 2 includes a data collection unit (139) that receives, gathers, and stores the process data. In one or more embodiments, the data collection unit (139) is a computer, connected to the downhole and surface sensors via an interface. In one or more embodiments, the data collection unit (139) is located in the vicinity of the well exit (105), as illustrated in FIG. 1. In other examples, data collection unit (139) may be located anywhere. In one or more embodiments, the data acquisition system (221) further acquires environmental data (227), including, for example, but not limited to a weather forecast, a report of a seismic activity or geospatial data, that are also collected in the data collection unit (139). In this case, acquiring the environmental data (227) can be done in several ways. For example, the data collection unit (139) may be directly connected to a meteorological station, from which it collects a weather forecast.

FIG. 2 also depicts a database (231), in accordance with one or more embodiments. The database (231) may include process data from one or more known hydrocarbon production wells, including process data from the present hydrocarbon production well (201). The database (231) may further include gas-lift efficiency data (235) from the same known hydrocarbon production wells, including past gas-lift efficiency data from the present hydrocarbon production well (201). Gas-lift efficiency depends on several factors, including the rate at which gas is injected into the production tubing, the gas-lift valve design, the wellbore design and the production fluid properties such as its viscosity. In one or more embodiments, the gas-lift efficiency data (235) include the flow rate of the production fluid. The database (231) may further include gas migration data (237) from the same known hydrocarbon production wells, including past gas migration data from the present hydrocarbon production well (201). Gas migration data may include the date at which the gas migration events have occurred, the volume of the migrated gas as well as a description of the resulting damages.

In one or more embodiments, the database (231) is interactive in the sense that it receives data from the data acquisition system (221) of the present hydrocarbon production well (201) in real-time, that can be accessed and used by other systems, such as the gas-lift monitoring system (241).

In accordance with one or more embodiments, the gas-lift monitoring system (241) makes use of, at least, a computational model (245). In one or more embodiments, the gas-lift monitoring system (241) further includes a computer (243), on which the computational model (245) is hosted and run. The role of the computational model (245) includes detecting gas migration events in real-time. In one or more embodiments, the computational model (245) further evaluates a gas-lift efficiency metric in real time and predicts future gas migration events. An example of a gas-lift efficiency metric is the ratio of a production fluid flow rate at the well exit over a volume of injected gas. In one or more embodiments, the computational model (245) includes an artificial intelligence (AI) model (247), that performs one or more of the tasks assigned to the computational model (245). In one or more embodiments, the tasks performed by the (AI) model (247) include detecting gas migration events in real time as a gas migration status, defined as either “positive” if a gas migration is detected, or “negative” if a gas migration is not detected. In one or more embodiments, the gas migration status is obtained from a probability that a gas migration event has occurred, computed by the AI model (247). Computational models that may be used to determine the real-time gas migration status or future gas migration events include, but are not limited to, anomaly detection models. In one or more embodiments, the computational model (245) includes a physics-based model, that simulates the fluid flow in the gas-lifted well under different gas injection rates and production rates. The model can predict the pressure and temperature profiles along the wellbore and potentially identify circumstances that can lead to gas migration. In one or more embodiments, according to the results of the computational model (245), the gas-lift monitoring system (241) determines one or more maintenance actions and adjustments to be made to one or more operation parameters in the set of operation parameters. Maintenance actions as determined by the gas-lift monitoring system (241) may include restorative maintenance actions if a gas migration event is detected in real-time, and preventive maintenance actions if a future gas migration is detected. The purpose of the adjustments to be made to one or more operation parameters, determined by the gas-lift monitoring system (241), may include mitigating a gas migration event in case a gas migration event is detected, optimizing a production rate of the production well based on the gas-lift efficiency, and preventing a future gas migration event. As noted in the description of FIG. 1, examples of operation parameters include, but are not limited to a gas-lift stability, a gas injection rate, a gas injection pressure, a gas-to-liquid ratio, valve opening and closing pressures and a hydrocarbon production rate. When a gas migration is detected in real-time, the computational model (245) further generates an alert that a gas migration is detected. The alert can have various forms. Examples of alerts that a gas migration is detected include, but are not limited to a sound, a visual alert, such as a display on a screen, the launch of a program on the computer (243), and a list of restorative maintenance actions designed to mitigate the gas migration event. In one or more embodiments, the gas-lift monitoring system (241) is configured to receive feedback about the effectiveness of the adjustments made to the operation parameters, and the computational model (245) is refined according to this feedback. In one or more embodiments, the adjustments to the operation parameters, determination of maintenance actions, or determination of preventive maintenance actions determined by the gas-lift monitoring system (241) are made by using artificial intelligence.

In one or more embodiments, maintenance actions identified by the gas-lift monitoring system (241) are automatically executed through one more commands transmitted to the hydrocarbon production well (201) (e.g., hydrocarbon production command X (281)) and one or more commands transmitted to the gas-lift system (211) (e.g., gas-lift command Y (283)). In one or more embodiments, the gas-lift monitoring system (241) is connected to an enterprise resource planning system and the command X (281) and command Y (283) may include automatically scheduling and allocating resources for maintenance actions. In the example in FIG. 2, adjustments of the operation parameters and maintenance actions related to the hydrocarbon production well (201) are made through the hydrocarbon production command X (281), while the operation parameters, maintenance actions related to the gas-lift system (211) are made through the gas-lift command Y (283). In one or more embodiments, the adjustments of the operation parameters included in the hydrocarbon production command X (281) and gas-lift command Y (283) are automatically made by the computer (243) or any other computing device, without human intervention.

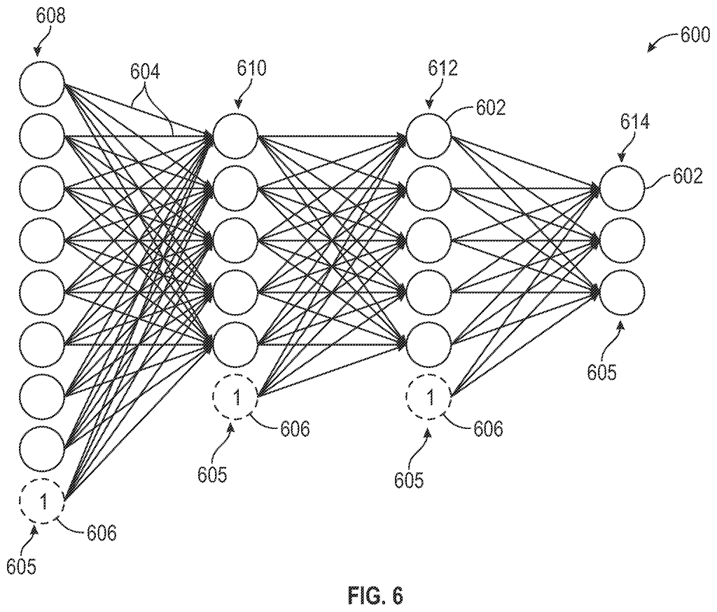

AI models typically involve a training-testing phase using previously acquired data before being put into production and applied to current data as predictors of future events. It is noted that the AI model (247) is connected to both the data acquisition system (221) and database (231). The database (231) contains previously acquired data from known wells in the form of process data (233), gas-lift efficiency data (235), and gas migration data (237), that may be used to train and test the AI model (247). In one or more embodiments, the database (231) further contains previously acquired environmental data from known wells (237), that may also be used to train and test the AI model (247). Once trained and tested, the AI model (247) receives input process data, and possibly environmental data (227) from the data acquisition system (221) related to the current hydrocarbon production well (201) and produces new pieces of gas-lift efficiency data and gas migration data as outputs, related to the current hydrocarbon production well (201). These new pieces of gas-lift efficiency data and gas migration data as outputs, related to the current hydrocarbon production well (201), may be sent and added to the gas-lift efficiency data (235) and gas migration data (237) in the database (231). The process data from the data acquisition system (221) related to the current hydrocarbon production well (201) may also be sent and added to the database (231), in the process data from known wells block (233). In one or more embodiments, the environmental data (227) from the data acquisition system (221), related to the current hydrocarbon production well (201), may also be sent and added to the database (231), in the environmental data from known wells block (239).Then, the AI model (247) may be re-trained or fine-tuned using the database (231) that now includes these new pieces of data, resulting in continuous training or fine-tuning of the AI model (247). In the case that the maintenance model (249) is also an AI model, it may also be trained or fine-tuned continuously in a similar fashion. A more complete description of the mechanics of an example of an AI model is given in FIG. 6.

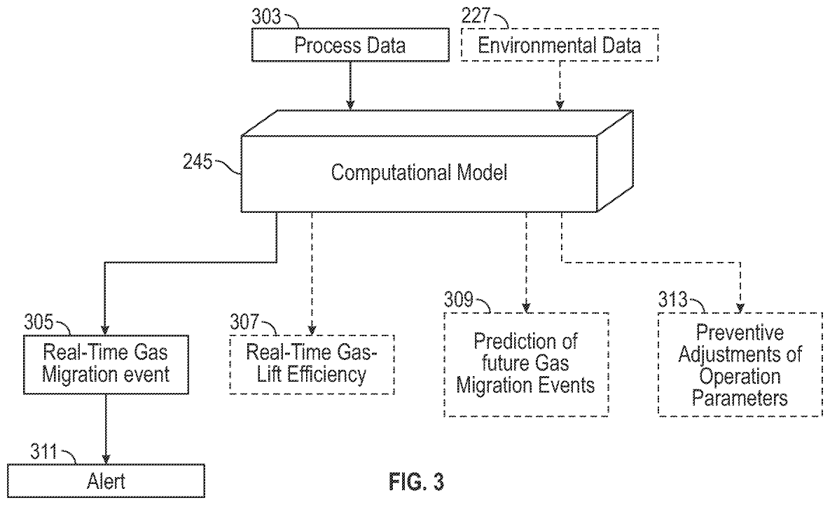

FIG. 3 depicts a high-level overview of the computational model (245), in accordance with one or more embodiments. Process data (303) acquired while producing hydrocarbons using a gas-lift production well is fed into the computational model (245). The computational model (245) processes the process data (303) and may detect a real-time gas migration event (305). If a gas migration event (305) is detected, a maintenance action is determined, based on the gas migration event, to repair any damaged equipment, and adjustments are determined to be made to one or more operation parameters in the set of operation parameters to mitigate the gas migration event. If a gas migration event (305), an alert (311) is made to alert for the gas migration event (305). In one or more embodiments, the computational model (245) further returns a real-time gas-lift efficiency (307). Then, based on the gas-lift efficiency (307), adjustments are determined to be made to one or more operation parameters in the set of operation parameters to optimize a production rate of the production well. In one or more embodiments, the computational model (245) further receives environmental data (227) and may further return a prediction of a future gas migration events (309). In case a future gas migration (309) is predicted, a preventive maintenance action is determined to prevent the predicted gas migration from occurring. In one or more embodiments, the preventive adjustments of one or more operation parameters (313) in the set of operation parameters are determined, by the computational model (245), to prevent a future gas migration event, regardless of whether a future gas migration has been predicted. In one or more embodiments, the computational model (245) is periodically updated, based on latest research and industry standards, to enhance the performance of gas migration event detection.

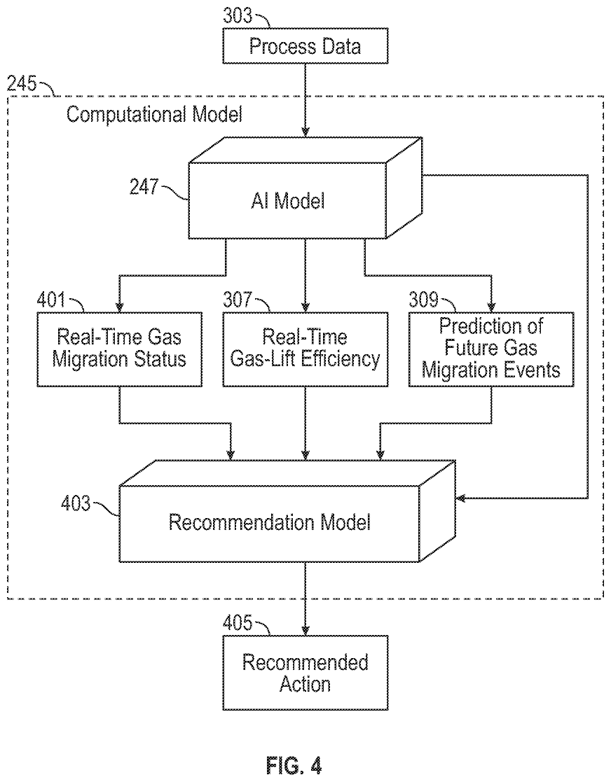

FIG. 4 depicts a high-level overview of the AI model (247) included in the computational model (245), in accordance with one or more embodiments. As seen in FIG. 3, in one or more embodiments, process data (303) acquired while producing hydrocarbons using a gas-lift production well is fed into the AI model (247). The AI model (247) processes the process data (303) and returns a real-time gas migration status (401), a real-time gas-lift efficiency (307), and a prediction of future gas migration events (309), which are then passed on to a recommendation model (403), through which maintenance actions and adjustments of some the operation parameters are determined. In one or more embodiments, the AI model (247) includes an anomaly detection model to compute the real-time migration status (401) and make prediction of future gas migration events (309).

In one or more embodiments, the process data (303) received by the AI model (247) includes downhole data (223), such as downhole gas flow rate, downhole gas injection rate, downhole liquid production rate, downhole pressure, downhole temperature, downhole gas concentration and a subsurface equipment failure and maintenance report, as well as surface data (225), such as surface pressure, surface temperature, gas injection pressure, gas injection temperature and a surface equipment failure and maintenance report. The list of examples of process data provided in this paragraph are not intended to be exhaustive. Many other process data may be used.

The AI model (247) in FIG. 4 may take various forms. Examples of AI models include machine learning models. That said, in one or more embodiments, the AI model (247) is an anomaly detection model. Anomaly detection models help identify abnormal spikes in data, such as a sudden increase in a gas flow rate, which could indicate a gas migration event. Examples of anomaly detection models include statistical process control charts, moving average algorithms, and support vector machines. Statistical control charts identify points that fall outside an expected range based on statistics. Moving average algorithms compute a moving average of a specified number of data points and compare another data point to the moving average. If this other data point falls outside a specified range around the moving average, it is flagged as an anomaly. Support vector machines separate anomalous data points from non-anomalous data points by creating a geometrical separation between anomalous data points and non-anomalous data points. An example of such a geometrical separation is a hyperplane, on one side of which data points are said to be anomalous, and on the other side of which data points are said to be non-anomalous.

Artificial intelligence (AI), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI) is adopted herein. However, one skilled in the art will recognize that the concepts and methods detailed hereafter are not limited by this choice of nomenclature.

AI models (e.g., AI model (247)) model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

In accordance with one or more embodiments, the computational model (245), that determines at least the real-time gas migration status (307), is a Support Vector Machine (SVM). A SVM is a supervised machine learning algorithm that is commonly used for classification and anomaly detection. The training of a SMV includes finding a hyperplane that separates the data into two classes: anomalous data and non-anomalous data. Once such a hyperplane has been determined, any point on one side of the hyperplane is considered to be an anomaly, while any point on the other side of the hyperplane is considered not to be an anomaly. Therefore, it is sufficient to determine on which side of the hyperplane a data point lies in order to determine whether or not the data point is an anomaly. When determining whether or not the process data imply that a gas migration (305) is occurring, an anomaly detection SVM may be trained, for which an anomaly is defined as the gas status being “abnormal”, and a non-anomaly is defined as the gas status being “normal”.

In accordance with one or more embodiments, the computational model (245), that at least predicts real-time gas migration events (305), is a neural network (NN). For example, a neural network model may be trained to predict the expected hydrocarbon production rate for a given set of input variables such as injection gas rate, downhole pressure, or downhole temperature. A predicted hydrocarbon production rate that differs significantly from the actual hydrocarbon production rate, as measured by the downhole sensors, could indicate a gas migration event.

A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer.” A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (602) and edges (604) and f is a user-defined function. Incoming nodes (602) are those that, when the neural network (600) is viewed or depicted as a directed graph (as in FIG. 6), have directed arrows that point to the node (602) where the numerical value is being computed. Some functions for f may include the linear function f(x)=x, sigmoid function

$$f ( x ) = \frac{1}{1 + {e}^{- x}} ,$$

and rectified linear unit function f(x)=max(0, x), however, many additional functions are commonly employed. Every node (602) in a neural network (600) may have a different associated activation function. Often, as a shorthand, activation functions are described by the function f by which it is composed. That is, an activation function composed of a linear function f may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Training data is provided to the neural network (600). Generally, training data consists of pairs of inputs and associated targets. The targets represent the “ground truth,” or the otherwise desired output, upon processing the inputs. In the context of the instant disclosure, an input is process data, or during training, process data from one or more known wells, and its associated target is a set made of some or all of the three following elements: a real-time gas migration indicator, the real-time gas-lift efficiency (307), and the prediction of future gas migration events (309). Thus, as seen and in accordance with one or more embodiments, training the AI model (247) makes use of the historical database (231). During training, the neural network (600) processes at least one input from the training data and produces at least one output. Each neural network (600) output is compared to its associated input data target. The comparison of the neural network (600) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target. The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target over the training data. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

A structural grouping, or group, of weights is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (600), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (600) to produce a final output. Note, that in this context, the neural network (600) is still considered part of the CNN. Like unto a neural network (600), a CNN is trained, after initialization of the filter weights, and the edge (604) values of the internal neural network (600), if present, with the backpropagation process in accordance with a loss function.

In the specific embodiment in FIG. 4, the recommendation model (403) is included in the computational model (245). The recommendation model (403) performs various determination tasks, including some of the following (a),(b),(c),(d), and (e): (a) if the gas migration status is returned as “positive” by the AI model (247), determining a maintenance action, based on the gas migration event, to repair any damaged equipment, and (b) determining adjustments to be made to one or more operation parameters in the set of operation parameters to mitigate the gas migration event; (c) based on the gas-lift efficiency returned by the AI model (247), determining adjustments to be made to one or more operation parameters in the set of operation parameters to optimize a production rate of the production well; (d) in case a future gas migration is predicted by the AI model (247), determining a preventive maintenance action to prevent the predicted gas migration from occurring; (e) regardless of whether a gas migration event has been detected or predicted, preventively adjust one or more operation parameters in the set of operation parameters in order to prevent a future gas migration event. The actions determined by the recommendation model (403), including some of (a),(b),(c),(d), and (e), are recommended as a recommended action (405).

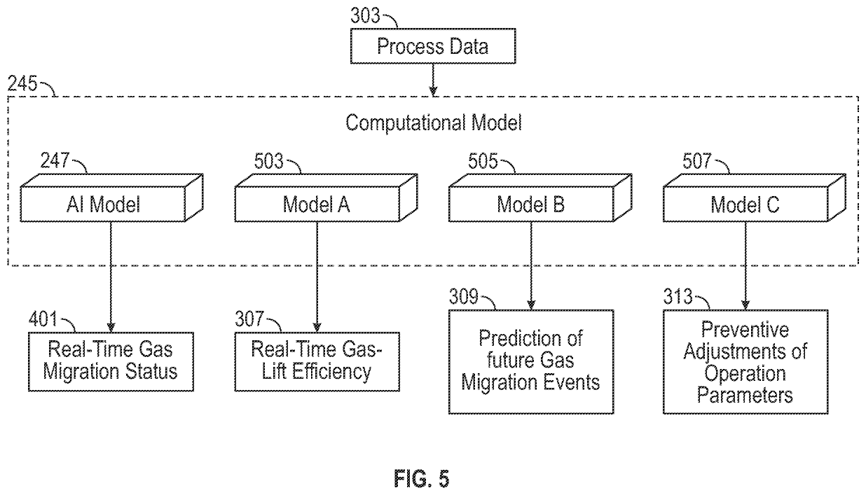

FIG. 5 depicts another embodiment of a high-level overview of the computational model (245). Process data (303) acquired while producing hydrocarbons using a gas-lift production well is fed into the computational model (245). In this embodiment, the computational model (245) is made of three separate models that operate separately: AI model (247), Model A (503), and Model B (505). The AI model (247), introduced in FIG. 2, determines the real-time gas migration status 401. Model A (503) returns the real-time gas-lift efficiency (305). In one or more embodiments, Model A (503) is an AI model. Model B (505) determines possible future gas migration events (309). In one or more embodiments, Model B (505) is also an AI model. Model C (507) determines adjustments to be made to one or more operation parameters (313) in the set of operation parameters, to prevent a future gas migration event, regardless of whether a future gas migration has been predicted. In one or more embodiments, Model C (507) is also an AI model.

It is emphasized that there are many ways of defining the computational model (245) to accomplish the goal of this disclosure. FIGS. 3, 4 and 5 are intended to provide examples only and should not be considered as limiting. In other examples, the computational model (245) may include two or more models, which could be AI models, and run separately or sequentially.

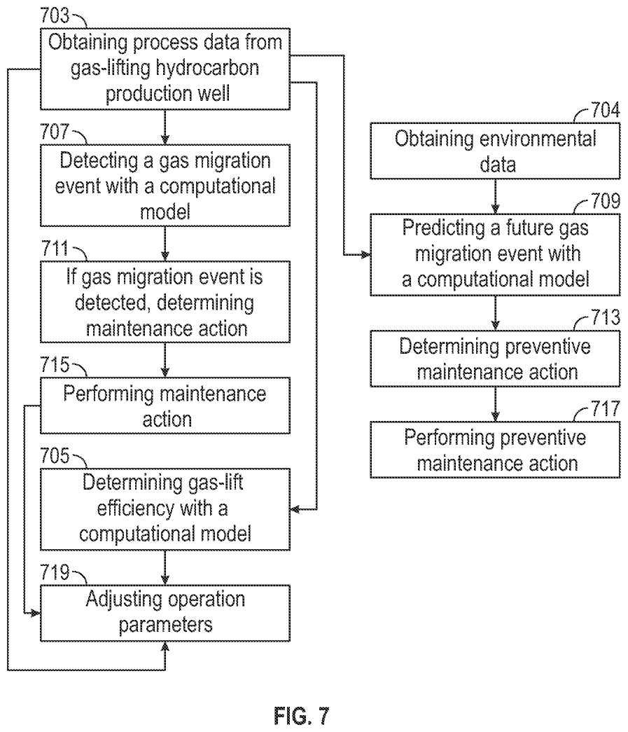

The flowchart in FIG. 7 outlines the main steps in the process of monitoring a gas-lift system and performing the resulting maintenance actions. Initially, in Step 701, process data are obtained from a gas-lift hydrocarbon production well. As described in view of FIG. 2, process data may include downhole data (225) and surface data (227). In one of more embodiments, some of the process data may be acquired by downhole sensors (135) and surface sensors (137), as depicted in FIG. 1.

In connection with Step 703, a real-time gas migration event (305) may be detected by the computational model (245) in Step 707, that receives the process data as input. In one or more embodiments, the gas migration event (305) is detected by determining a gas migration status (401), defined as “positive” is a gas migration is detected, and “negative” is no gas migration is detected. That is, the gas migration status (401) is either “negative” or indicates the occurrence of a gas migration event. In the latter case, the gas migration event (305) may further include descriptive information such as: a suspected location of gas migration; a volume of migrated gas; etc. In one or more embodiments, the result of Step 707 may be given as a probability of an on-going gas migration event, rather than a definite certainty.

If a gas migration is detected in Step 707, the process continues to Step 711, in which a maintenance action is determined, based on the gas migration event, to repair any damaged equipment. Examples of maintenance actions include re-cementing the wellbore where a structural weakness allowed the gas to migrate, replacing or repairing corroded surface from abrasive particles carried by the movement of gas and fluids, and inspecting the site thoroughly in case other gas migration events are close to occurring.

In Step 715, the maintenance actions determined in Step 711 are performed, such as re-cementing the wellbore where a structural weakness allowed the gas to migrate, replacing or repairing corroded surface from abrasive particles carried by the movement of gas and fluids, and inspecting the site thoroughly in case other gas migration events are close to occurring.

Following the maintenance made in Step 715, one or more operation parameters may be adjusted in the set of operation parameters in Step 719 to mitigate the gas migration event. If the maintenance is intensive in accordance with one or more embodiments, the adjustments may include a temporary disruption of hydrocarbon production. That is, adjustments may be made to temporarily stop or halt production in order to realize a prescribed maintenance action. In one or more embodiments, the effects of the adjustments to one or more operation parameters in the set of operation parameters are simulated by the computational model (245), prior to being implemented, and may be modified, based on the results of the simulation.

Also connected with Step 703, a real-time gas-lift efficiency (307) is determined by the computational model (245) in Step 705, that receives the process data as input. In one or more embodiments, the computational model (245) is a neural network and outputs a real-time gas-lift efficiency metric for the gas-lift system (211). In one or more embodiments, a gas-lift efficiency metric is based on a ratio of a production fluid flow rate at the well exit over a volume of injected gas.

As part of Step 719, one or more operation parameters may be adjusted, based on the real-time gas-lift efficiency output from Step 705, in order to improve gas-lift efficiency and therefore, optimize a production rate of the production well. In one or more embodiments, the set of operation parameters includes a gas-lift stability, a gas injection rate, a gas injection pressure, a gas-to-liquid ratio, and valve opening and closing pressures.

Directly connected to Step 703, Step 719 further includes, whenever suitable, adjusting one or more operation parameters in the set of operation parameters, in order to prevent a future gas migration event, regardless of whether a future gas migration has been predicted.

Environment data, obtained in Step, may include, for example, a weather forecast, a report of a seismic activity or geospatial data. Connected with Step 703 and Step 4, a future gas migration event may be predicted by the computational model (245) in Step 709, that receives the process data and environment data as input. In one or more embodiments, a gas migration can occur due to several reasons, such as inadequate cementing, formation changes, or pressure differentials.

If future gas migration events are predicted in Step 709, determining preventive maintenance action follows in Step 713. The preventive maintenance action typically has an economic impact on the well operations, that must be weighed against the expected economic cost of a future gas migration event. Aside from the cost of performing the preventive maintenance action itself, an opportunity cost may be added to the economic balance in case that the preventive maintenance action requires a temporary disruption of the hydrocarbon production. Therefore, the preventive maintenance action is determined in accordance with a potential economic impact of performing such preventive maintenance action. One way of including the economic impact of performing such preventive maintenance action in determining the preventive maintenance action is to constrain the expected economic cost of the predictive maintenance action to be less than the expected economic cost of the predicted future migration event. In one or more embodiments, preventive maintenance includes installing flow meters, acoustic devices, gas detectors, or applying coatings, linings, or corrosion inhibitors to protect metal surfaces from corrosion and enhance cathodic protection.

In Step 717, the preventive maintenance actions determined in Step 713 are performed, such as installing flow meters, acoustic devices, gas detectors, or applying coatings, linings, or corrosion inhibitors to protect metal surfaces from corrosion and enhance cathodic protection.

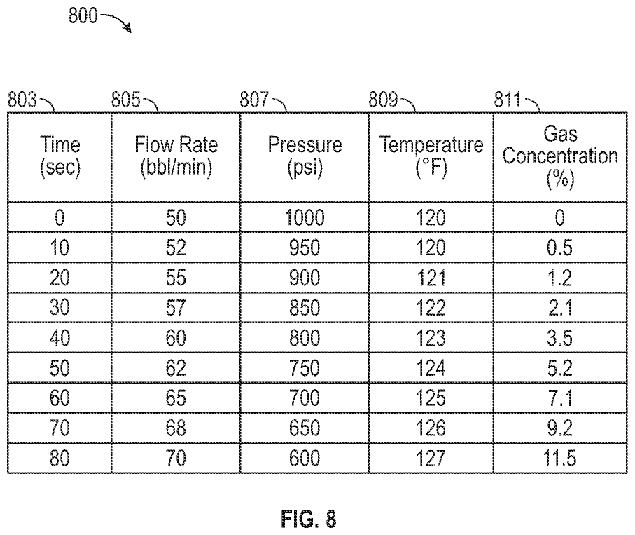

FIG. 8 presents some examples of process data. The time (803) represents the instants at which the data are acquired. The flow rate (805) is the rate at which the gas-hydrocarbon mixture flows from downhole to the surface, given in barrels per minute (bbl/min). The pressure (807), given in psi, is the pressure of gas-hydrocarbon mixture measured downhole. The temperature (809), measured in Fahrenheit (F), is the temperature of the gas-hydrocarbon mixture downhole. Finally, the gas concentration (811), expressed as a percentage, is the concentration of gas within the gas-hydrocarbon mixture. It is emphasized that the set of process data (800) depicted in FIG. 8 is given only as an example and should be considered non-limiting. One with ordinary skill in the art will recognize that the process data (800) used by the computational model (245) may omit or contain additional quantities not shown without departing from the scope of this disclosure.

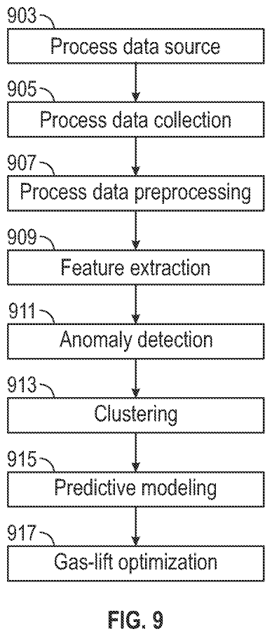

The flowchart in FIG. 9 depicts an example of obtaining process data, processing the process data through a computational model (245), and using the results of the computational model (245) to optimize the gas-lift parameters. In this example, the computational model contains at least preprocessing Step 907, feature extraction Step 909, anomaly detection model Step 911, clustering Step 913 and predictive modeling Step 915. In one or more embodiments, some of anomaly detection model Step 911, clustering Step 913 and predictive modeling Step 915 are AI models. In one or more embodiments, Gas-lift optimization Step 917 is also included in the computational model (245) and may further be an AI model.

In Step 903, process data are generated from a source, which in one or more embodiments is a gas-lift hydrocarbon production well (115), as shown in FIG. 1.

The process data are collected in Step 905. As mentioned in previous paragraphs, examples of process data include downhole gas flow rate, downhole gas injection rate, downhole liquid production rate, downhole pressure, downhole temperature, downhole gas concentration, subsurface equipment failure and maintenance report, surface pressure, surface temperature, gas injection pressure, gas injection temperature and a surface equipment failure and maintenance report. In one or more embodiments, the collected process data from step 905 are not perfectly suited for being used as input for a computational model such as (245). For example, the collected process data may be irregular, noisy, missing values, or of a non-desirable format.

In one or more embodiment, process data preprocessing Step 907 includes making the process data collected in Step 905 suitable to be used as an input to a computational model. Examples of data preprocessing that may be performed in Step 905 involve cleaning, transforming, and organizing raw data into a different format. For instance, some of the data from equipment failure and maintenance reports may be a text, that should be encoded to a number format before being processed by a machine. Other examples of preprocessing procedures include handling missing data, removing outliers, denoising and normalization.

Preprocessed data from Step 907 often contain a large number of attributes, also called features, that may include redundant or irrelevant information. In one or more embodiments, feature extraction Step 909 aims to reduce the number of features while retaining the essential patterns and characteristics of the data. Using the resulting data, after feature extraction, as input to the computational model (245) may improve the computational model performance. In case the computational model includes an AI model, using the resulting data, after feature extraction, as input for training the AI model, may prevent the AI model from overfitting. Examples of operations that may be performed through feature extraction are removal of correlated features and principal component analysis. Typically, two correlated features convey similar information to an AI model, which results in similar information being taken into consideration twice by the AI model. Therefore, such redundant information is artificially given twice its weight, compared to any information from non-correlated features that is conveyed only once. In one or more embodiments, when two features are correlated, either correlated feature is removed from the process data, hence conveying their information only once while reducing the number of features by one. In accordance with one or more embodiments, principal component analysis may be performed by computing the covariance matrix of all the features, then computing the eigenvectors of the covariance matrix, then selecting a subset of eigenvectors, and finally using this subset of eigenvectors as features while discarding the other eigenvectors.

In the next step, 911, the data from step 909 are processed for detecting on-going anomalies in the hydrocarbon operation process. Anomaly detection may refer to identifying observations that are unusual, unexpected, or potentially indicative of a problem or interesting events in the hydrocarbon operation process. In one or more embodiments, an anomaly is a gas migration event. Detecting on-going gas migration events is desirable, in order to take appropriate actions to prevent equipment damage, blowouts, or environment impacts. In one or more embodiments, the anomaly detection procedure in step 911 is a machine learning model, such as support vector machine or a deep neural network.

Clustering is performed in the next step, Step 913. In one or more embodiments, clustering includes grouping similar process data samples together based on certain features. The goal of clustering is to identify patterns and structures within the process data without using predefined labels or categories. Examples of clustering methods include machine learning models such as K-means, in which data samples are grouped into a certain number, denoted as K, of groups. The K groups are defined by the model itself, such that the average distance from the data samples to the centroid of each group is closest to minimal. In one or more embodiments, the distance used in the K-means algorithm is the Euclidian distance. In one or more embodiments, each group corresponds to a level of gas-lift efficiency. Assessing gas-lift efficiency levels allows for taking appropriate steps to optimize the gas-lift process in later Step 917.

In Step 915, predictive modeling is used to predict future events that may happen in the gas-lifted hydrocarbon production process. In one or more embodiments, such events are gas migration events. Predicting future gas migration events is desirable, in order to define a preventive maintenance strategy and prevent such events from happening. In one or more embodiments, predictive modeling may be performed by a Support Vector Machine (SVM) model.

Finally, in step 917, a set of actions is determined in order to optimize the gas-lift process. Following this, still in Step 917, these actions are performed. In one or more embodiments, optimizing the gas-lift process includes adjusting the gas injection flow rate or gas injection pressure. In one or more embodiments, Step 917 is part of the computational model (245) and may be an AI model.

It is emphasized that there are many ways of running a computational model (245) to accomplish the goal of optimizing gas-lift hydrocarbon production wells. The flowchart in FIG. 9 is intended to provide one example only. In one or more embodiments, some of the steps 903, 907, 909, 911, 913, 915 and 917 may be run simultaneously or in a different order. An example of running Steps 911, 913 and 915 simultaneously is a multiple-output NN, that computes the outputs of each of these steps simultaneously, but as a separate output.

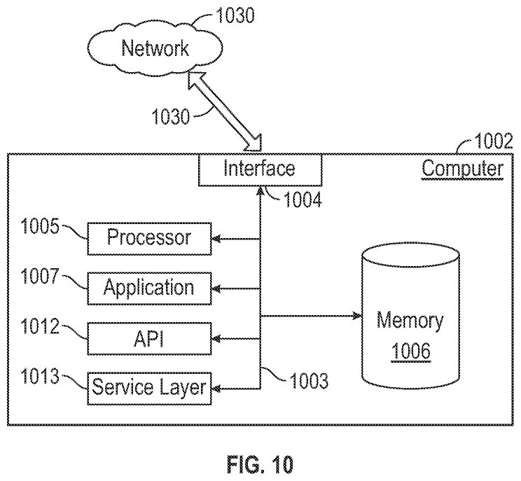

FIG. 10 depicts a block diagram of a computer system (1002) used to provide computational functionalities associated with described algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining process data from a gas-lifted, hydrocarbon production well, wherein the production well is controlled by a set of operation parameters;
detecting, with a computational model, a gas migration event based on the process data;
adjusting one or more operation parameters in the set of operation parameters to mitigate the gas migration event based on the gas migration event and the process data;
determining a maintenance action based on the gas migration event;
generating an alert for the detected gas migration event; and
performing the maintenance action on the production well.

2. The method of claim 1, further comprising:
determining, with the computational model, a gas lift efficiency of the production well based on the process data; and
adjusting one or more operation parameters in the set of operation parameters to optimize a production rate of the production well based on the gas lift efficiency.

3. The method of claim 2, further comprising:
obtaining environmental data related to the hydrocarbon production well, the environmental data comprising at least one of:
weather forecast data, and
seismic activity data;
predicting a future gas migration event by processing the process data and the environmental data with the computational model;
determining a first expected economic cost from the predicted future gas migration event;
determining a preventative maintenance action based on the predicted future gas migration event;
generating an alert for the predicted gas migration event;
making a first determination of whether a second expected economic cost of performing the preventative maintenance action is less than the first expected economic cost; and
performing the preventative maintenance action on the production well based on the first determination that the second expected economic cost is less than the first expected economic cost.

4. The method of claim 1, further comprising adjusting one or more operation parameters in the set of operation parameters, using the computational model, in order to prevent a future gas migration event.

5. The method of claim 1, wherein the process data comprises downhole data and surface data,
the downhole data comprising one of:
a downhole gas flow rate,
a downhole gas injection rate,
a downhole liquid production rate,
a downhole pressure,
a downhole temperature,
a downhole gas concentration, and
a subsurface equipment failure and maintenance report; and
the surface data comprising one of:
a surface pressure,
a surface temperature,
a gas injection pressure,
a gas injection temperature, and
a surface equipment failure and maintenance report.

6. The method of claim 3,
wherein the computational model comprises:
an artificial intelligence (AI) model that detects the gas migration event; and
a preventative maintenance model that predicts the future gas migration event; and
wherein the gas migration event is detected by determining, with the AI model, a gas migration status, where the gas migration status is either positive if a gas migration is detected, or negative if a gas migration is not detected.

7. The method of claim 6, wherein the AI model is an anomaly detection model.

8. The method of claim 3,
wherein the maintenance action is one of:
repairing cement,
repairing valves, and
replacing valves,
wherein the predictive maintenance action is one of:
improving cement condition,
replacing valves, and
updating hydrocarbon production equipment.

9. A system, comprising:
a hydrocarbon production well, controlled by a set of operation parameters;
a gas-lift system, coupled to the hydrocarbon production well, comprising:
a gas source;
a gas pump that pumps gas from the gas source into a wellbore of the hydrocarbon production well;
a data acquisition system that collects process data from a plurality of sensors disposed on the hydrocarbon production well; and
a computer comprising one or more computer processors and a user interface, the computer communicatively connected to the data acquisition system and configured to:
receive process data from the data acquisition system;
detect, with a computational model, a gas migration event based on the
process data;
adjust one or more operation parameters in the set of operation parameters to mitigate the gas migration event based on the gas migration event and the process data;
determine a maintenance action based on the gas migration event; and
generate an alert for the detected gas migration event;
wherein the maintenance action is performed on the production well,
wherein the user interface is configured to communicate, to a user, the detected gas migration event, the one or more adjusted parameters, and the determined maintenance action.

10. The system of claim 9, wherein the computer is further configured to:
determine, with the computational model, a gas lift efficiency of the production well based on the process data; and
adjust one or more operation parameters in the set of operation parameters to optimize a production rate of the production well based on the gas lift efficiency.

11. The system of claim 9, wherein the computer is further configured to:
receive environmental data related to the hydrocarbon production well, the environmental data comprising one or more of:
weather forecast data, and
seismic activity data;
predict a future gas migration event by processing the process data and the environmental data with the computational model;
determine a preventative maintenance action based on the predicted future gas migration event; and
generate an alert for the detected gas migration event,
wherein the preventative maintenance action is performed on the production well.

12. The system of claim 9, wherein the plurality of sensors comprise:
at least one downhole sensor, comprising one or more of:
a downhole gas flow rate sensor,
a downhole gas injection rate sensor,
a downhole liquid production rate sensor,
a downhole pressure sensor,
a downhole temperature sensor, and
a downhole gas concentration sensor, and
at least one surface sensor, comprising one or more of:
a surface pressure sensor,
a surface temperature sensor,
a gas injection pressure sensor, and
a injection temperature sensor.

13. The system of claim 10, wherein the process data comprises:
downhole data comprising one or more of:
a downhole gas flow rate,
a downhole gas injection rate,
a downhole liquid production rate,
a downhole pressure,
a downhole temperature,
a downhole gas concentration, and
a subsurface equipment failures or maintenance report, and
surface data, comprising one or more of:
a surface pressure,
a surface temperature,
a gas injection pressure,
a gas injection temperature, and
surface equipment failures or a maintenance report.

14. The system of claim 11,
wherein the computational model comprises:
an artificial intelligence (AI) model that detects the gas migration event; and
a preventative maintenance model that predicts the future gas migration event; and
wherein the gas migration event is detected by determining, with the AI model, a gas migration status, where the gas migration status is either positive if a gas migration is detected, or negative if a gas migration is not detected.

15. The system of claim 14, wherein the AI model is an anomaly detection model.

16. A non-transitory computer-readable memory comprising computer-executable instructions stored thereon that, when executed on a processor, cause the processor to perform steps comprising:
obtaining process data from a gas-lifted, hydrocarbon production well, wherein the production well is controlled by a set of operation parameters;
detecting, with a computational model, a gas migration event based on the process data;
adjusting one or more operation parameters in the set of operation parameters to mitigate the gas migration event based on the gas migration event and process data;
determining a maintenance action based on the gas migration event; and
generating an alert for the detected gas migration event,
wherein the maintenance action is performed on the production well.

17. The non-transitory computer-readable memory of claim 16, the steps further comprising:
determining, with the computational model, a gas lift efficiency of the production well based on the process data; and
adjusting one or more operation parameters in the set of operation parameters to optimize a production rate of the production well based on the gas lift efficiency.

18. The non-transitory computer-readable memory of claim 17, the steps further comprising:
obtaining environmental data related to the hydrocarbon production well, the environmental data comprising one or more of:
weather forecast data, and
seismic activity data;
predicting a future gas migration event by processing the process data and the environmental data with the computational model;
determining a preventative maintenance action based on the predicted future gas migration event; and
generating an alert for the detected gas migration event,
wherein the preventative maintenance action is performed on the production well.

19. The non-transitory computer-readable memory of claim 18 wherein the computational model comprises:
an artificial intelligence (AI) model that detects the gas migration event; and
a preventative maintenance model that predicts the future gas migration event; and
wherein the gas migration event is detected by determining, with the AI model, a gas migration status, where the gas migration status is either positive if a gas migration is detected, or negative if a gas migration is not detected.

20. The non-transitory computer-readable memory of claim 19, wherein the AI model is an anomaly detection model.
